(19) United States
(12) Patent Application Publication
(10) Pub. No.: US 2007/0131480 A1
(43) Pub. Date: Jun. 14, 2007

(54) SOUND ARRESTING BARRIER

(76) Inventors: Maxwell H. Corbin JR., Milford Center, OH (US); Lee Burch, Ft. Thomas, KY (US)

Correspondence Address: WOOD, HERRON & EVANS, LLP, 2700 CAREW TOWER, 441 VINE STREET, CINCINNATI, OH, 45202, US

(21) Appl. No.: 11/567,500

(22) Filed: Dec. 6, 2006

Related U.S. Application Data
(63) Continuation-in-part of application No. 11/005,334, filed on Dec. 6, 2004.

(51) Int. Cl. B64F 1/26; E04B 9/00

(52) U.S. Cl. 181/210; 181/285

(57) ABSTRACT

A sound barrier comprises a plurality of elongate sound arresting members arranged end to end and stacked vertically, one upon another, to form a barrier wall. The sound arresting members are disposed generally between a plurality of spaced vertical support members and may be secured thereto by a plurality of elongate transition connectors coupled to each support members. The elongate transition connectors have distal ends that extend in directions toward oppositely disposed support members and are received within apertures formed in respective ends of the sound arresting members at their respective ends. Alternatively, the sound arresting members may be coupled to the spaced vertical supports without transition connectors.

This application is a continuation-in-part of U.S. patent application Ser. No. 11/005,334, filed Dec. 6, 2004, now pending.

### TECHNICAL FIELD

The present invention relates generally to acoustic structures, and more particularly to a sound barrier for eliminating or reducing noise emanating from roadways, railways, airports or other noise generating areas.

### BACKGROUND

Sound barrier walls are known in the art and have been utilized to reduce or eliminate noise transmitted from roadways, airports, railways, or other such areas to adjacent residential and business communities. These sound barriers are typically constructed in the form of elongate wall structures interposed between a noise source and an area that is desired to be protected from the noise. When such sound barriers are erected along roadways and bridges, it is desirable to construct the sound barrier such that it is able to act as a vehicle impact barrier structure as well as a noise barrier. In particular, it is desirable to prevent automobiles, trucks and other vehicles from passing through the barrier into the adjacent protected area. This is particularly important when the barriers are used along bridges and overpasses, where the vehicle should be redirected back onto the roadway. In addition, it is desirable that the barrier be constructed such that a vehicle impacting the structure is not snagged while proceeding along the length of the structure.

Conventional sound barriers capable of providing vehicle impact resistance have generally been constructed from concrete or other materials that greatly add to the weight of barrier components. Installation and transportation of these conventional barrier components is difficult and requires the use of power equipment. To address these installation difficulties, lightweight barriers have been proposed, but lightweight sound barriers have offered only minimal protection against the passage of vehicles through the structure. Therefore, a need exists for a sound barrier which eliminates or reduces noise transmitted from roadways, railways and other such areas, and which is able to provide vehicular impact protection while being cost efficient and easy to install.

### SUMMARY

The present invention provides a sound barrier system that not only reduces noise transmitted from roadways, railways or other noise generating areas, but also serves as an impact barrier for errant vehicles which may strike the barrier. In one embodiment, the sound barrier comprises a series of spaced vertical posts, or support members, arranged in a desired area between the noise source and the area to be protected, such as along a roadway, railway, or other noise generating area. A plurality of elongate sound arresting members extend generally between the support members and are stacked one atop another to form a barrier wall. Each sound arresting member is connected at its distal ends to the vertical support members. In one embodiment, elongate transition connectors are coupled to each support member and are spaced apart along the lengths of the support members. Each transition connector has an arm extending toward an oppositely disposed one of the support members. The arms are received in apertures formed in the ends of the sound arresting members such that the sound arresting members are frictionally engaged by the transition connectors.

In another embodiment, the distal ends of the sound arresting members are disposed within channels provided on the respective support members. A top one of the sound arresting members may be secured at its distal ends to the support members by fasteners.

In another embodiment, each sound arresting member is formed from polymeric material and has a generally tubular, unitary construction such that the sound arresting members may be formed by known methods, such as pultrusion or extrusion, for example. In yet another embodiment, the sound arresting members are formed from fiber-reinforced polymeric material. The sound arresting members are formed with a tongue and groove construction, the tongues and grooves formed on respective oppositely disposed sides of the sound arresting members to facilitate interlocking adjacent sound arresting members when they are stacked one atop another to form a sound barrier wall.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an exemplary sound barrier installed along a roadway, in accordance with the invention;

FIG. 2 is an elevation view depicting an exemplary sound barrier in accordance with the invention and utilized along a bridge overpass;

FIG. 3 is an exploded partial perspective view of a sound barrier in accordance with the invention;

FIG. 4 is a perspective view depicting an exemplary sound barrier wall in accordance with the invention;

FIG. 5 is a partial cross-sectional view of the sound barrier of FIG. 4, taken along line 5-5;

FIG. 6 is a cross-sectional view of the sound barrier of FIG. 2, taken along line 6-6;

FIG. 7 is a partial elevation view depicting another sound barrier in accordance with the invention;

FIG. 8 is a top cross-sectional view depicting another sound barrier in accordance with the invention;

FIG. 9A is a cross-sectional view, similar to FIG. 5, depicting another sound barrier in accordance with the invention;

FIG. 9B is a cross-sectional view, similar to FIG. 9A, depicting yet another sound barrier in accordance with the invention;

FIG. 10 is a perspective view depicting another exemplary sound barrier in accordance with the invention;

FIG. 11 is a cross-sectional view of the sound barrier of FIG. 10, taken along line 11-11;

FIG. 12 is perspective view, similar to FIG. 4, depicting another exemplary sound barrier wall in accordance with the invention; and

FIG. 13 is a cross-sectional view of the sound barrier of FIG. 12, taken along line 13-13.

### DETAILED DESCRIPTION

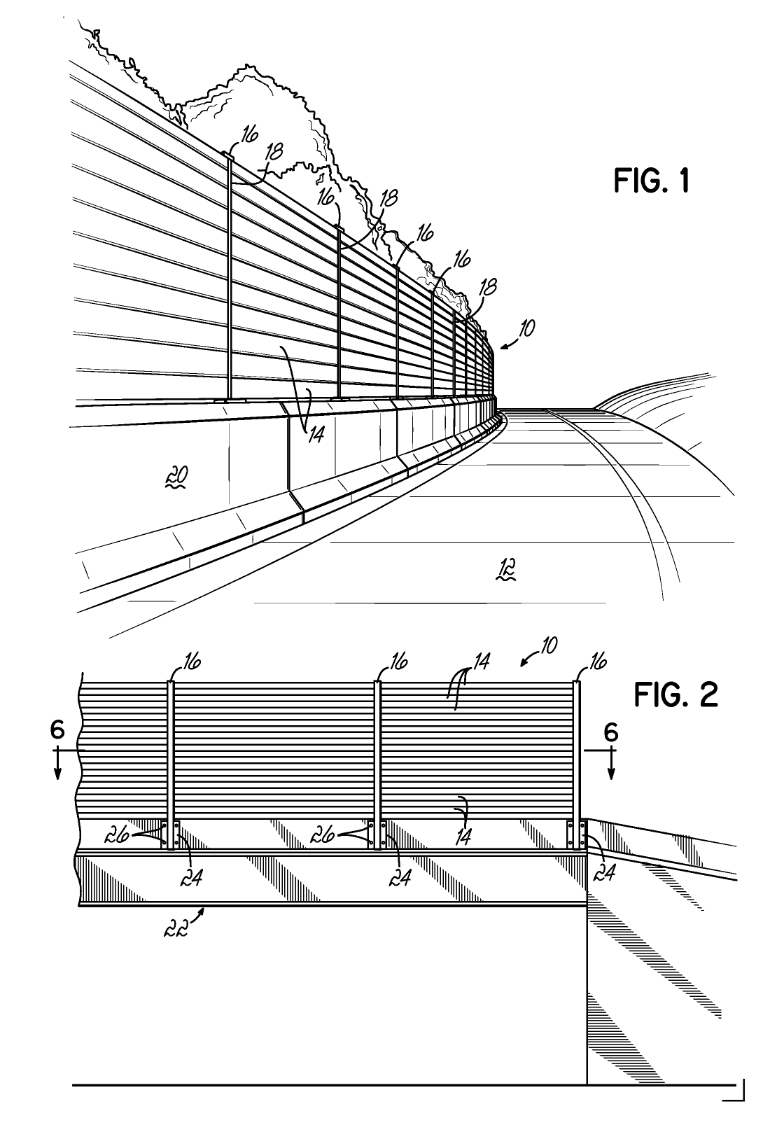

FIG. 1 depicts an exemplary sound barrier 10 according to the present invention and utilized along a roadway 12 to eliminate or reduce noise transmitted from the roadway 12 to the adjacent area on the opposite side of the sound barrier 10. The sound barrier 10 comprises a series of elongate sound arresting members 14 arranged end-to-end and stacked in a vertical direction, one atop another, to create a wall or partition between the noise generating area and the area to be protected. The sound arresting members 14 are supported by a series of spaced vertically disposed posts, or support members 16, arranged along the boundary between the noise source and the protected area. Vertical cover strips 18 are provided along the joints between the ends of the sound arresting members 14, generally opposite the support members 16. In FIG. 1, the sound barrier 10 is constructed along the side of the roadway 12 and is positioned atop a parapet or retaining wall 20. It will be recognized however that the sound barrier 10 may alternatively be erected directly upon the ground surface.

FIG. 2 depicts another embodiment of a sound barrier 10 according to the present invention. In this embodiment, the sound barrier 10 is erected along the edge of a bridge overpass 22. The view of FIG. 2 depicts the side of the sound barrier 10 which faces the protected area, such that the vertical support members 16 are visible. The support members 16 are secured to the bridge structure, such as by brackets 24 fastened directly to the bridge structure by bolts 26. FIGS. 1 and 2 depict only two possible configurations of a sound barrier 10 according to the present invention. It will be recognized that various other embodiments are possible, for example, for use along railways, at the boundary of airport runways, and surrounding industrial areas.

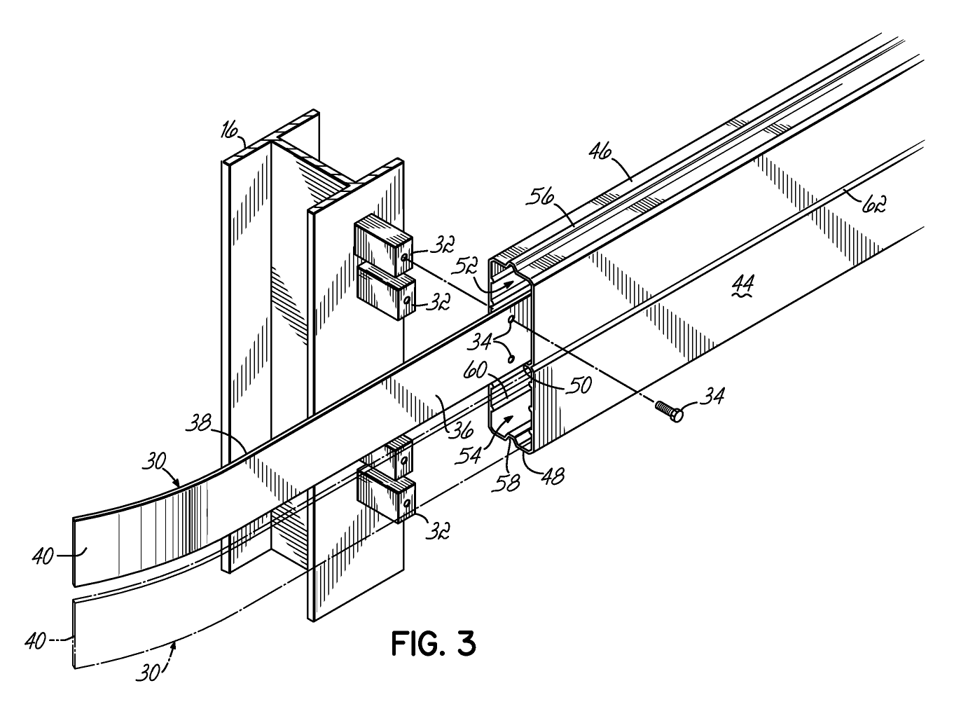

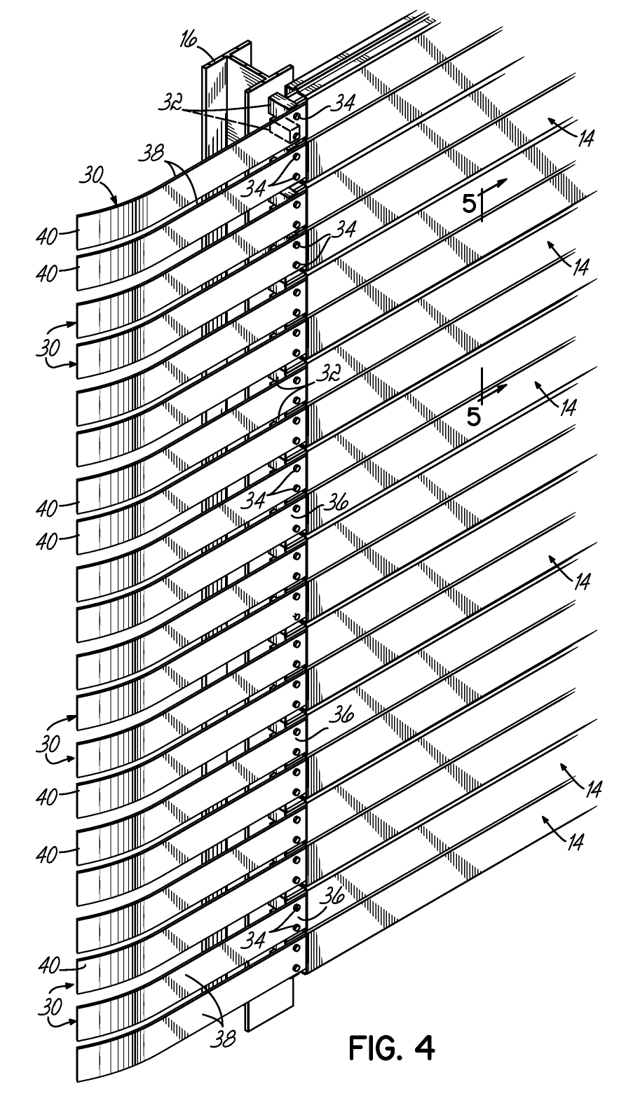

Referring now to FIGS. 3 and 4, detail of an exemplary construction of a sound barrier 10 according to the present invention will now be described. Each sound arresting member 14 is secured at its distal ends to support members 16. The support member 16 depicted in FIG. 3 is a steel I-beam, however it will be recognized that the support member may comprise wooden posts, concrete, or other materials suitable to support the sound arresting members 14 and provide structural integrity to the sound barrier 10.

A plurality of transition connectors 30 are secured to the sides of the support members 16 to which the sound arresting members 14 will be attached and are spaced from the support members 16 by stand-offs 32 secured thereto. In the embodiment shown, the transition connectors 30 are secured to the stand-offs 32 by threaded fasteners 34, however it will be recognized that the transition connectors 30 may be secured by other methods, such as rivets, welding, or by corresponding interlocking features formed on the stand-offs 32 and transition connectors 30. The transition connectors 30 are generally elongate in shape and are secured at a first portion 36 to the stand-offs 32. Each transition connector 30 has an arm 38 that extends toward oppositely disposed support members 16 to receive the sound arresting members 14 thereon. Second portions 40 of the transition connectors 30, proximate the distal ends of the arms 38, are angled to extend obliquely to the central portions 36. Apertures are formed in the respective ends of each sound arresting member 14 and the ends of the sound arresting members 14 are slid over the arms 38 of the transition connectors 30 such that the transition connectors 30 frictionally engage the sound arresting members 14.

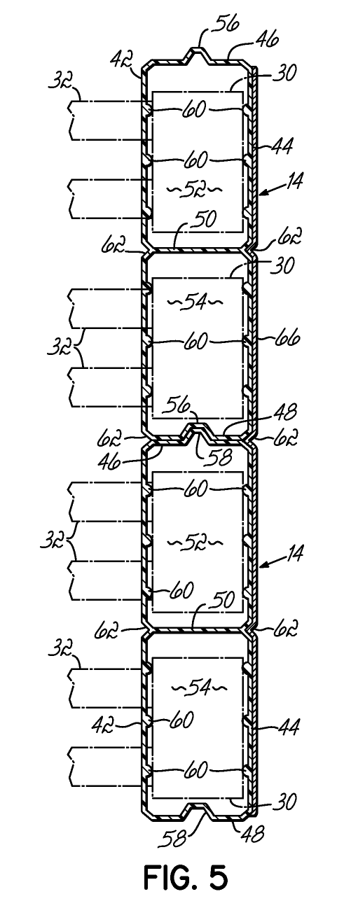

With continued reference to FIGS. 3 and 4, and referring further to FIG. 5, the exemplary sound arresting members 14 comprise elongate tubular structures having first and second opposing sidewalls 42, 44, upper and lower walls 46, 48, and an intermediate wall 50 formed between the sidewalls 42, 44 and positioned parallel to the upper and lower walls 46, 48 to form adjacent first and second channel sections 52, 54 that extend along the length of the sound arresting members 14. Accordingly, the transition connectors 30 are arranged in pairs on the support members 16 such that the distal ends of each pair of transition connectors 30 are slidingly received within the first and second channel sections 52, 54 of the sound arresting members 14.

The pairs of transition connectors 30 are spaced apart from other pairs of transition connectors 30 secured to the support members 16 such that the sound arresting members 14 may be stacked one atop another to form a barrier wall as depicted in FIGS. 4 and 5. The sound arresting members 14 further include tongue and groove formations 56, 58 formed in the upper and lower walls 46, 48, respectively, and extending lengthwise along the sound arresting members 14, so that when the sound arresting members 14 are stacked one atop another, the respective tongue and groove formations 56, 58 engage one another to align and interlock the stacked sound arresting members 14. The sound arresting members 14 may further include raised ridges 60 and recesses 62 formed lengthwise along the sidewalls 42, 44 to increase the flexural strength of the sound arresting member 14. In one embodiment, the sound arresting members 14 may further include a coating of sound absorbing material 66 provided on an outwardly facing surface thereof, such as sidewall 44.

In another embodiment, the sound arresting members 14 are formed from polymeric material and the tubular construction of the sound arresting members 14 facilitates manufacture by methods such as pultrusion and extrusion. In another embodiment, the sound arresting members 14 are formed from fiber-reinforced polymeric material or other composite material suitable for attenuating or otherwise reducing noise transmitted from a noise generating area. Exemplary dimensions for sound arresting members 14 formed from fiber-reinforced polymeric material are approximately 12 inches overall height and approximately 3.5 inches overall width. The wall thickness is approximately 0.14 inch. The sound arresting members may be provided in lengths up to approximately 24 feet. In one embodiment, the transition connectors 30 are formed from 10-gauge galvanized steel and extend approximately 3 feet out from the centers of the support members 16. The transition connectors 30, together with the sound arresting members 14, add structural strength to the sound barrier 10 sufficient to prohibit vehicles from penetrating the sound barrier 10. Moreover, the angled second portions 40 of the transition connectors 30 facilitate directing errant vehicles that impact the sound barrier 10 back onto the roadway. In this embodiment, the sound barrier 10 is configured to meet the requirements of the National Cooperative Highway Research Program (NCHRP) crash test level IV. This test specifies that a ten-wheeled delivery truck which impacts the wall or parapet must be re-directed back onto the road surface without snagging on the wall or rolling over.

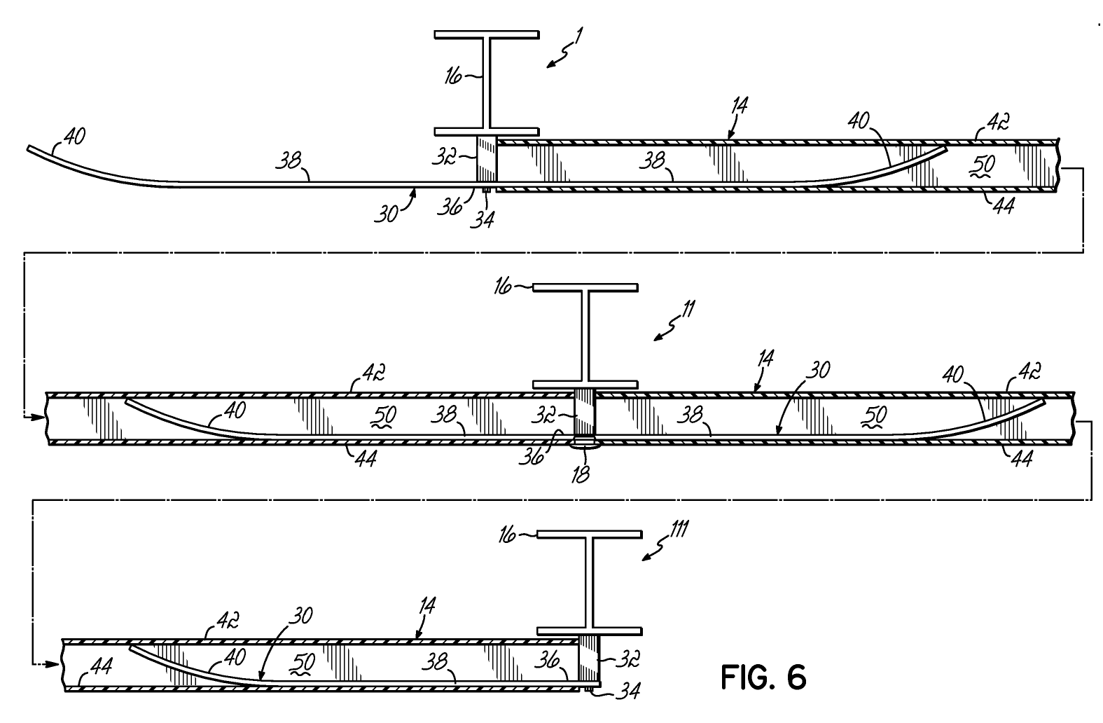

FIG. 6 is a cross-sectional view of an exemplary sound barrier 10 according to the present invention viewed from above. The figure depicts three segments I, II, III of a sound barrier wall. The first I segment depicts an intermediate portion of the wall wherein a transition connector 30 is fixed to a support member 16 such that it extends in opposite directions on either side of the support member 16. The first portion of the transition connector 36 is secured to the support member 16 and extends in directions toward oppositely disposed support members 16. The second portions 40 of the transition connector 30 are angled to extend in directions oblique to the first portion 36, as described above, whereby the first and second portions cooperate to frictionally engage sound arresting members 14 slid over the transition connector 30. This first segment I is shown with a sound arresting member 14 provided on only one side of the transition connector 30, similar to FIGS. 3 and 4. During installation of the sound barrier 10, corresponding sound arresting members 14 are slid over the exposed ends of the transition connectors 30, as will be described in more detail below.

The second segment II depicted in FIG. 6 is also an intermediate portion of the wall, but sound arresting members 14 are provided on both ends of the transition connectors 30. The third segment III depicts a terminal or end portion of the sound barrier 10 wherein the transition connectors 30 have only one distal end extending from its support member 16 toward an oppositely disposed support member 16. This configuration provides a convenient way to terminate the wall and prevent the sound arresting members 14 from sliding off of the transition connectors 30, however, it will be recognized that other configurations for terminating the wall are possible.

To erect a sound barrier 10 according to the present invention, the support members 16 are placed in the ground or attached to other support surfaces at intervals corresponding to the span of the sound arresting members 14. The transition connectors 30 and sound arresting members 14 are then secured to the support members 16 to create the wall structure. At the outset, the transition connectors 30 may be secured to the first support member 16 and the ends of the sound arresting members 14 slid over the transition connectors 30, as depicted in FIGS. 4 and 6. Subsequent adjacent sections are added by sliding respective transition connectors 30 into the free ends of the sound arresting members 14 and securing the transition connectors 30 to a respectively associated support member 16. The process is repeated until the terminal portion of the sound barrier 10 is reached. At the terminal portion, transition connectors 30 having arms 38 that extend in only one direction are slid into the free ends of the sound arresting members 14 and are secured to their respectively associated support member 16, as depicted in FIG. 6.

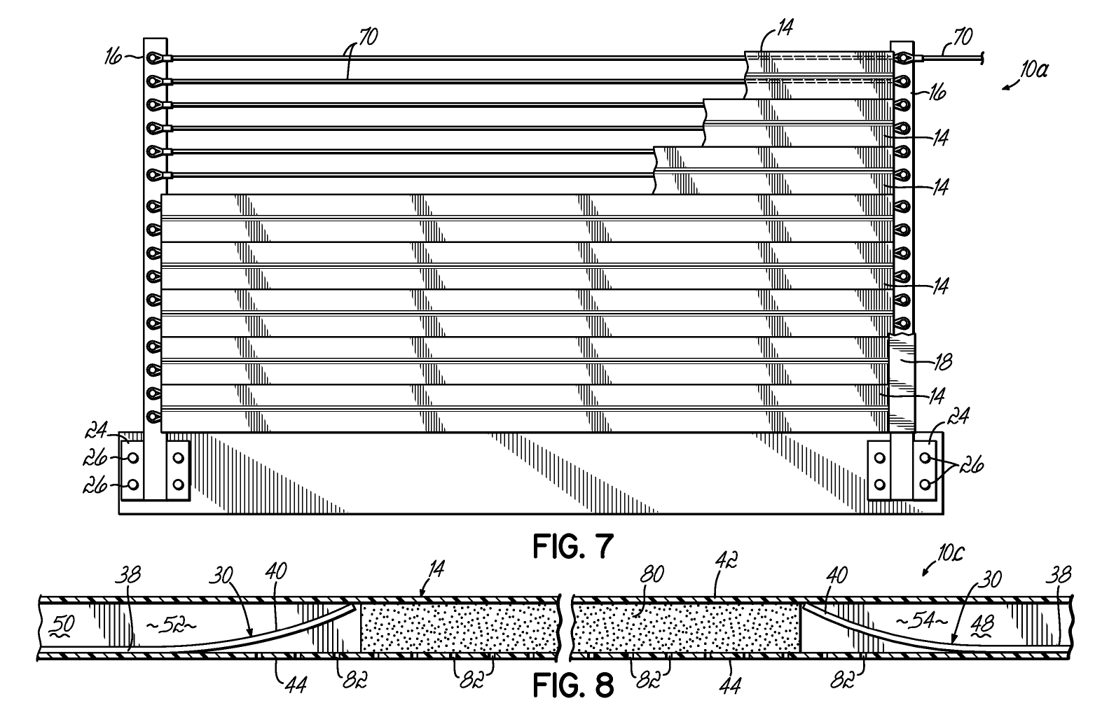

Referring now to FIG. 7, there is shown another exemplary sound barrier 10a according to the present invention. Sound barrier 10a is similar to the sound barrier 10 shown and described above, with the exception that the sound arresting members 14 are supported on the vertical support members 16 by a plurality of cables 70 extending between respective support members 16. In the embodiment shown, ¾-inch diameter wire rope cable 70 is secured to each support member 16 to extend therebetween. To form the sound barrier 10a, cables 70 are inserted through the first and second channel sections 52, 54 of a sound arresting member 14. The free ends of the cables 70 are then secured to respective support members 16. Additional cables 70 and sound arresting members 14 may be secured between the support members 16 and stacked one upon another, in a manner similar to that described above, to form the barrier wall.

Referring now to FIG. 8, there is shown a top, cross-sectional view of yet another exemplary sound barrier 10c according to the present invention. Sound barrier 10c is similar to the sound barrier 10, shown and described above, but further includes sound absorbing material 80 disposed in the first and second channel sections 52, 54 of the sound arresting member 14. In the embodiment shown, the sound absorbing material 80 comprises Styrofoam and extends within the first and second channel sections 52, 54 between the transition connectors 30 secured to respectively opposing post members 16. In this embodiment, the sound arresting members 14 further include perforations 82 formed in the second sidewall 44 of the sound arresting member (the side facing the noise source) whereby noise from the noise source enters through the perforations of the sound arresting member 14 and is absorbed by the noise absorbing material 80. In this manner, the sound barrier 10c both reflects and absorbs noise from the noise source.

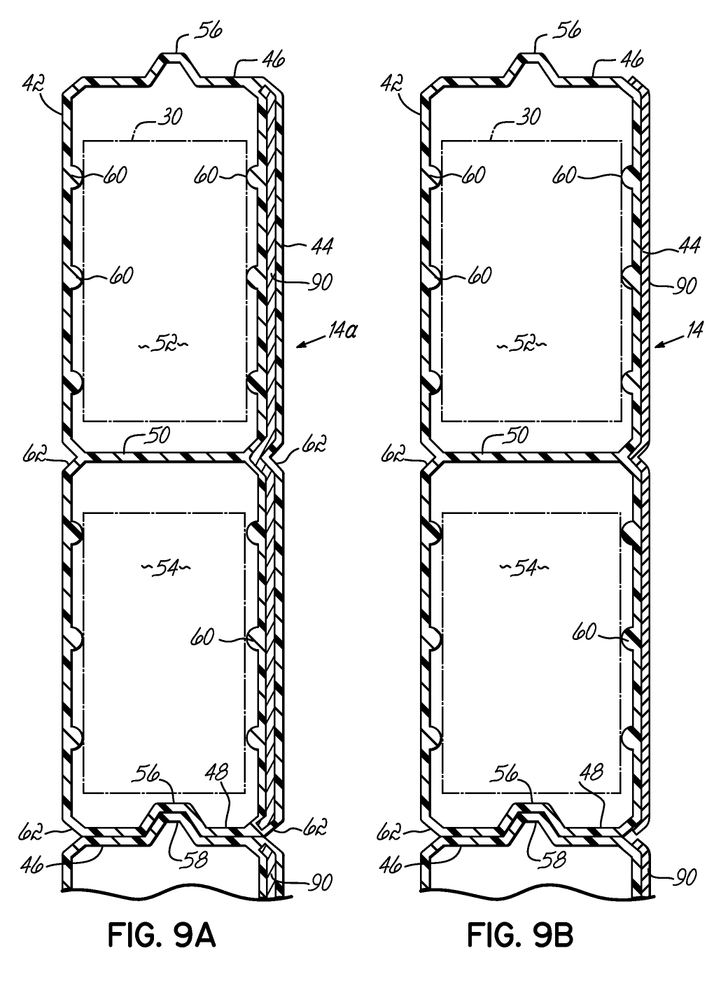

FIG. 9A depicts another sound arresting member 14a in accordance with the invention, and which can be used in any of the sound barriers shown and described herein. In this embodiment, the second sidewall 44 of the sound arresting member 14a includes a reinforcing material 90 in the form of a wire mesh formed into the sidewall 44. One such reinforcement is a reinforcing “tape” formed from twisted steel wire manufactured by Hardwire, LLC of Pocomoke City, Md. It will be recognized that various other reinforcing materials could be used, such as carbon fibers, unwoven metal or fabric strands, or any other material suitable for reinforcing the sound arresting member. In FIG. 9A, the reinforcing material 90 is formed directly into the sidewall 44, or other portions of the sound arresting member 14a, such as by molding, pultrusion, extrusion or other methods. Alternatively, the reinforcement 90 may be applied to an outer surface of a sound arresting member 14, as depicted in FIG. 9B.

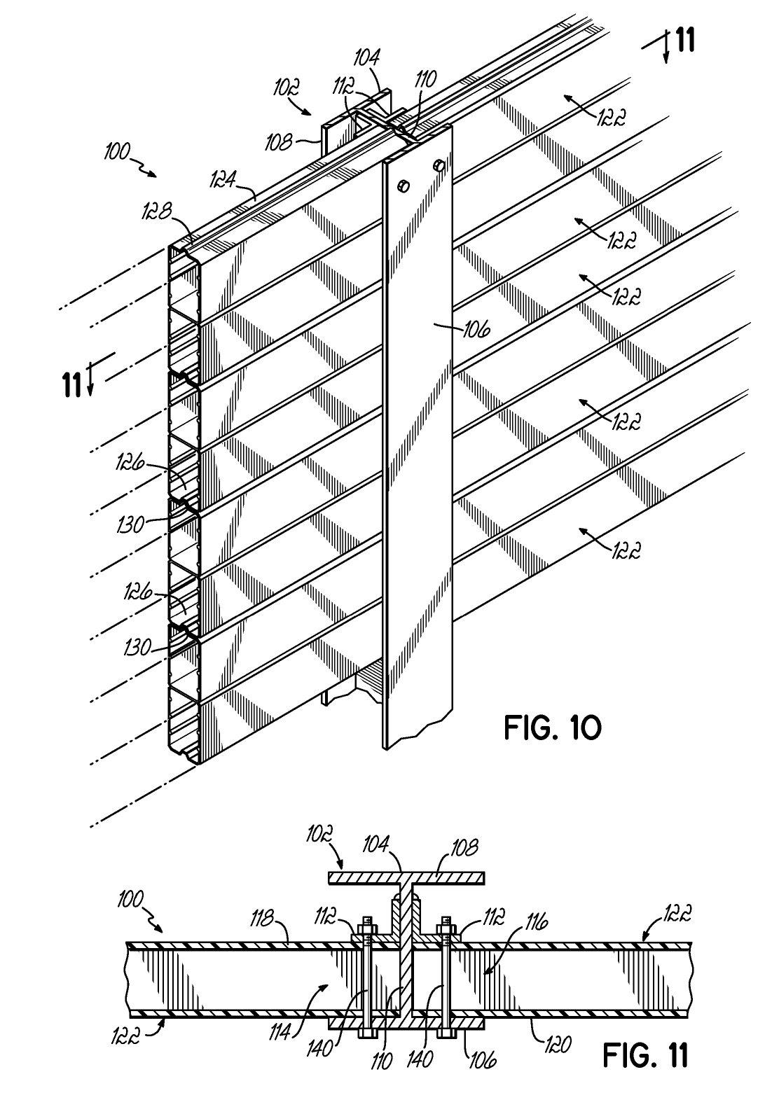

FIGS. 10 and 11 depict another exemplary embodiment of a sound barrier 100 in accordance with the principles of the present invention. In this embodiment, the sound barrier 100 includes a series of spaced, vertically disposed posts or support members 102 arranged along the boundary between a noise source and a protected area. In the embodiment shown, the support members 102 comprise I-beams 104 having first and second oppositely disposed end walls 106, 108 and an intermediate web 110 extending therebetween. L-shaped brackets 112 are secured to the intermediate web 110 along the length of the I-beam 104 to define vertically extending channels 114, 116 for receiving ends 118, 120 of sound arresting members 122 as will be described more fully below.

The sound barrier 100 further includes a plurality of elongate sound arresting members 122 stacked in a vertical direction, one atop another, with the respective upper and lower walls 124, 126 of adjacent sound arresting members 122 abutting one another to form a vertical wall between first and second support members 102. The upper and lower walls 124, 126 include complementary interlocking features that are engaged with one another to align and interlock the stacked sound arresting members 122. In the embodiment shown, the interlocking features include an outwardly protruding tongue 128 on the upper wall 124, and a groove 130 on the lower wall 126 and extending lengthwise along the sound arresting members 122. It will be appreciated, however, that other complimentary interlocking features may be provided on the respective upper and lower walls 124, 126 to facilitate aligning and interlocking the stacked sound arresting members 122.

With continued reference to FIGS. 10 and 11, the respective first and second lateral ends 118, 120 of the stacked sound arresting members 122 are received within the respective channels 114, 116 of the first and second support members 102 so that the sound arresting members 122 are maintained in vertical alignment between the first and second support members 102.

The sound barrier 100 may further include one or more fasteners 140 extending through an end wall 106 of the I-beam 104, through at least one sound arresting member 122, and through the L-shaped bracket 112 to secure the stack of sound arresting members 122 relative to the support members 102. In the embodiment shown, fasteners 140 extend through only the upper most sound arresting members 122 to secure the stack of sound arresting members 122. While a threaded fastener 140 is shown and described for securing the sound arresting members 122 to the support members 102, it will be appreciated that various other methods may be used to secure the stack of sound arresting members 122 relative to the support members 102.

In contrast to the sound barriers shown and described with respect to FIGS. 1-8, 9A and 9B, the sound barrier 100 of FIGS. 10 and 11 does not include transition members or other support structure extending between the respective support members 102. A computer analysis of the sound barrier 100 of this embodiment was performed to simulate a crash test in accordance with the NCHRP Test Level 4 requirements. Surprisingly, this computer analysis indicated that a sound barrier 100 constructed in accordance with FIGS. 10 and 11 was capable of passing the NCHRP level IV crash test without the need for transition members or other structure extending between the support members 102.

In the embodiment shown in FIGS. 10 and 11, the sound arresting members 122 are formed in a manner similar to that described above with respect to FIGS. 3-5. Specifically, the sounds arresting members 122 are formed from polymeric material and may be manufactured by methods such as protrusion and extrusion. The sound arresting members 122 may be formed from fiber-reinforced polymeric material or other composite material suitable for attenuating or otherwise reducing noise transmitted from a noise generating area. In one embodiment, each sound arresting member 122 comprises extruded polymeric material having a weight density of no more than about 4 pounds per linear foot, making the sound arresting members 122 relatively light, while still attenuating noise and redirecting errant vehicles onto the roadway. To further attenuate noise from a noise source, the sound barrier 100 may further include sound absorbing material provided on an outer surface of the sound arresting members 122. Alternatively, sound absorbing material may be disposed within the sound arresting members 122, between the first and second sidewalls, as described above with respect to FIGS. 5 and 8.

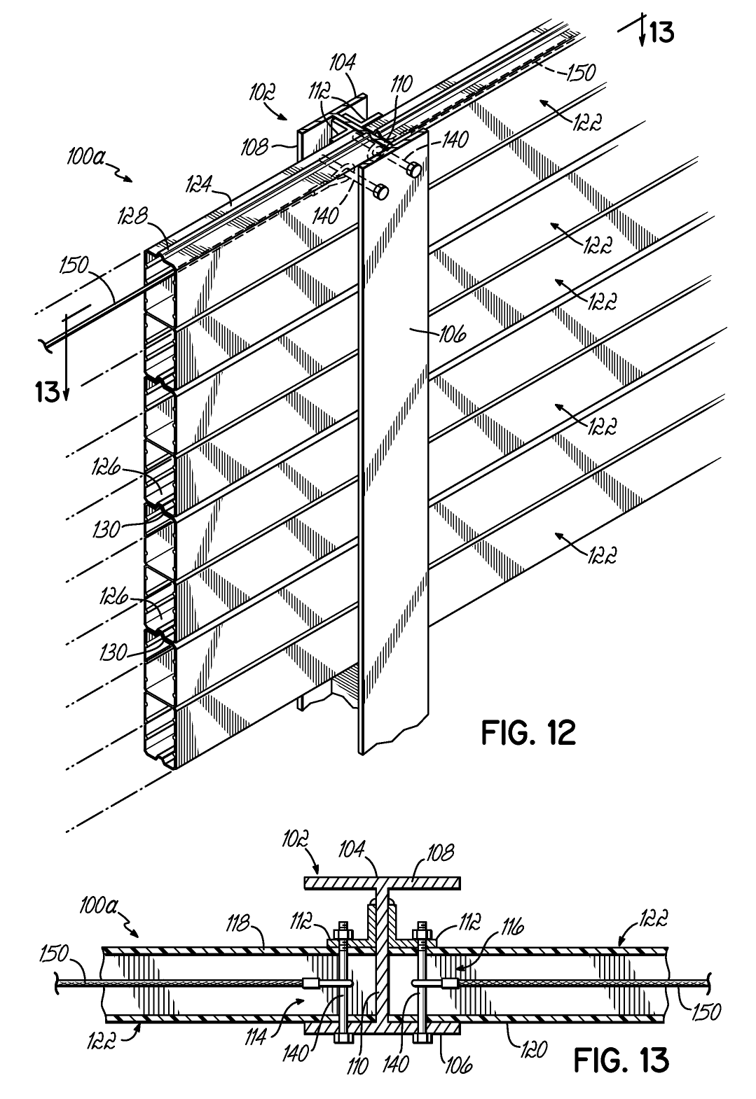

FIGS. 12 and 13 depict yet another exemplary sound barrier 100a, similar to the sound barrier 100 discussed above with respect to FIGS. 10 and 11, wherein similar features have been similarly numbered. Sound barrier 100a further includes at least one cable 150 extending between the first and second vertical support members 102. Cable 150 may be disposed in the uppermost sound arresting member 122 of the stack of sound arresting members 122 forming sound barrier 100a and may be secured at its ends to respective support members 102, such as by fasteners 140 for example, in a manner similar to that discussed above with respect to cables 70 in the sound barrier 10a of FIG. 7. The cable 150 provides additional support to help retain the uppermost sound arresting member 122 in position on the sound barrier 100a in the event that a vehicle impacts the sound barrier 100a. Otherwise, the construction of sound arresting members 122 is the same as discussed above.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. A sound barrier, comprising:
first and second laterally spaced support members, each said support member including at least one vertically extending channel;
a plurality of elongate sound arresting members having first and second laterally spaced ends, upper and lower walls, and first and second oppositely disposed sidewalls;
complementary interlocking features on said upper and lower walls;
said plurality of sound arresting members stacked to form a vertical wall between said first and second support members, with respective upper and lower walls of adjacent sound arresting members abutting one another and said complementary interlocking features engaged;
said laterally spaced ends of said plurality of sound arresting members forming said vertical wall disposed within respective ones of said channels of said first and second support members.

2. The sound barrier of claim 1, further comprising:
a fastener between one of said support members and at least one of said sound arresting members to secure said sound arresting member relative to said support member.

3. The sound barrier of claim 1, wherein each said sound arresting barrier comprises polymeric material extruded to define said first and second sidewalls, said upper and lower walls, and at least one intermediate wall between said first and second sidewalls.

4. The sound barrier of claim 1, wherein each sound arresting barrier comprises extruded polymeric material and has a weight density of no more than about 4 pounds per linear foot.

5. The sound barrier of claim 1, further comprising sound absorbing material on an outer surface of said sound arresting members.

6. The sound barrier of claim 1, further comprising sound absorbing material within said sound arresting members, between said first and second sidewalls.

7. The sound barrier of claim 1, further comprising at least one cable extending between said first and second laterally spaced support members and through one of said sound arresting members.

8. The sound barrier of claim 7, wherein said cable extends through an uppermost one of said sound arresting members stacked to form said vertical wall.

9. A sound barrier, comprising:
first and second laterally spaced support members;
a plurality of elongate sound arresting members;
said plurality of sound arresting members stacked to form a vertical wall between said first and second support members; and
at least one cable extending between said first and second laterally spaced support members and through one of said sound arresting members.

10. The sound barrier of claim 9, further comprising:
a fastener between one of said support members and at least one of said sound arresting members to secure said sound arresting member relative to said support member.

11. The sound barrier of claim 9, wherein each said sound arresting barrier comprises polymeric material extruded to define first and second sidewalls, upper and lower walls, and at least one intermediate wall between said first and second sidewalls.
